(19) United States
(12) Patent Application Publication
(10) Pub. No.: US 2008/0271327 A1
(43) Pub. Date: Nov. 6, 2008

(54) Powered Saw

(76) Inventor: Joseph P. Glynn, St. Louis, MO (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 10/585,683

(22) PCT Filed: Jan. 5, 2005
(86) PCT No.: PCT/US2005/000146

§ 371 Date: Jul. 28, 2008

(51) Int. Cl. B27B 19/00; B23D 53/00; B26B 7/00; B26B 1/00

(52) U.S. Cl. 30/509; 30/380; 30/277.4; 30/320

(57) ABSTRACT

A powered saw 1 includes a frame 3 with a continuous loop blade 5 positioned in a coplanar relationship with the frame 3 along a system of blade guides 7 so that a cutting surface 9 of the blade 5 faces a desired cutting area. The relative positions between the frame arms 13, the frame handle 2, and the blade 5 provides a degree of stability and control that allows the operator to precisely and accurately control the cutting surface 9 of the blade 5 along curves, notches, and protrusions, including those involved in coping. In addition, this arrangement results in a compact design that positions the cutting surface 9 in close proximity to the handle 2.

### CROSS-REFERENCE TO RELATED APPLICATIONS

This application is related to U.S. Provisional Patent Application No. 60/535,292 filed Jan. 9, 2004, and 60/558,170 filed Mar. 31, 2004, both from which priority is claimed, the disclosures of which are hereby incorporated by reference.

### TECHNICAL FIELD

This invention relates generally to hand held cuffing power tools. While the invention is described in particular detail with respect to a particular type of saw known as a “coping saw,” those skilled in the art will recognize the wider applicability of the inventive principles disclosed hereinafter.

### BACKGROUND ART

Coping saws are well known in the art being primarily used in cutting and fitting molding pieces together in the corner junction of a room, referred to as “coping.” The purpose of coping is to make two pieces of molding match up at a corner without a seam, giving an aesthetic pleasing appearance of a continuous border of molding. To accomplish this, the coping saw must make a precise cut along one end of a piece of molding that follows the unique profile, including curves, indentations, and projections of the adjacent piece of molding.

Typically, the coping saw is a hand operated saw with a narrow blade that is held under tension within a U-shaped frame. However, using hand operated coping saws is a slow labor-intensive process. Attempts have been made to develop powered coping saws, but none of these attempts have provided a powered coping saw that is both efficient and ergonomic while still providing precise control of the cut.

Consequently, there is a need for a powered coping saw that if efficient and ergonomic that provides precise control of the cut.

### BRIEF DESCRIPTION OF THE DRAWINGS

In the accompanying drawings which form part of the specification:

FIG. 1 is a plan view of a first embodiment of the invention;

FIG. 2 is a partial end view of the first embodiment of the invention;

FIG. 3 is a left-side elevational view of the first embodiment of the invention;

FIG. 4 is a plan view of a second embodiment of the invention;

FIG. 5 is a partial end view of the second embodiment of the invention;

FIG. 6 is a plan view of a third embodiment of the invention;

FIG. 7 is a partial end view of the third embodiment of the invention;

FIG. 8 is a plan view of a fourth embodiment of the invention; and

FIG. 9 is a partial end view of the fourth embodiment of the invention.

Corresponding reference numerals indicate corresponding parts throughout the several figures of the drawings.

### BEST MODES FOR CARRYING OUT THE INVENTION

The following detailed description illustrates the invention by way of example and not by way of limitation. The description clearly enables one skilled in the art to make and use the invention, describes several embodiments, adaptations, variations, alternatives, and uses of the invention, including what is presently believed to be the best mode of carrying out the invention.

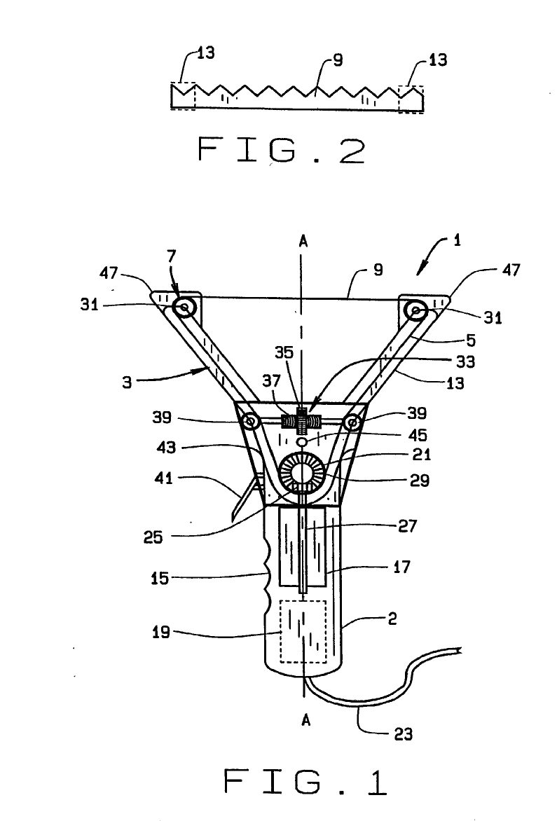

As shown in FIGS. 1-3, an embodiment of the present invention, generally referred to as a powered coping saw 1, includes a handle 2 having a frame 3 extending outwardly from the handle. The frame 3 has a continuous loop blade 5 positioned in a coplanar relationship with the frame 3 along a system of blade guides 7 so that a cutting surface 9 of the blade 5 faces a desired cutting area. In the present embodiment, the blade 5 is a band saw blade. However, those skilled in the art will recognize that any type of blade and/or replacement blade may be used, including, for example, an abrasive cable, wire blade, spiral blade, or cylinder blade, the term blade used in its generic sense as the cutting part of the saw 1. The ability to use multiple types of blades provides the coping saw 1 with the capability to cut multiple types of materials.

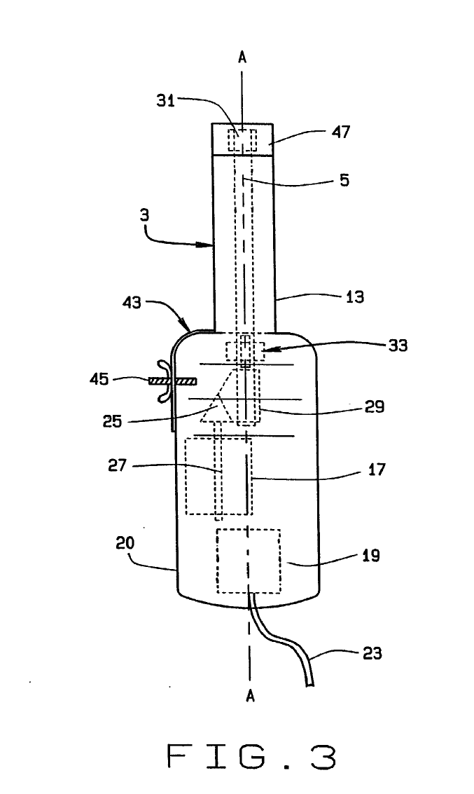

The frame 3 includes two arms 13 extending axially outwardly from an end of the handle 2 to form, in the embodiment illustrated, a generally Y-shape, the Y-shape defining an opening or throat 11. As will be appreciated by those skilled in the art, other shapes may be employed, if desired. For comfort and ease of use and control, handle 2 is ergonomically designed and includes notches 15 for fingers. Of course, the notches 15 may be located on any side of the handle 2 to accommodate the fingers of left-handed as well as right-handed operators. As shown in FIG. 3, handle 2 houses a motor 17, which is operatively connected between a suitable power supply 19, and a gear system 21. The gear system 21 in turn operatively connects the motor 17 to the blade 5 for transferring power to the blade 5. Various gear arrangements are compatible with the broader aspects of the invention. In this embodiment, the motor 17 is a variable speed electric motor that is electrically connected to the power supply 19, which comprises an electrical cord 23 that plugs into a standard 120V outlet. However, those skilled in the art will recognize that any suitable means of power supply may be used to power the motor 17 including by way of example and not of limitation, batteries, fuel cells, hydraulics, or air. Other embodiments may include a motor 17 that oscillates the blade 5 back and forth, instead of rotating the blade 5 around in a loop.

The gear system 21 includes a bevel drive gear 25 attached to a drive shaft 27 of the motor 17. The drive gear 25 couples with a driven gear 29, which is also housed within the handle 2. The driven gear 29 engages the blade 5 and, thus, drives the blade 5 around the system of blade guides 7. The gear system 21 may comprise any arrangement of gears that can transfer power from the motor 17 to the blade 5, including, for example, hypoid gears, miter gears, helical gears, worm gears, pinion gears or straight gears. The gear system 21 may also comprise gear configurations other than the embodiments shown in FIGS. 1 and 3, such as having additional gears that increase or decrease the torque and speed from the motor 17 to the blade 5, such as reduction gears. In an alternate embodiment (not shown), the gear system 21 has multiple gears that allow the operator to select from multiple speeds and torques similar to a transmission.

The system of blade guides 7 include blade guides 31, such as pulleys or roller bearings, mounted at the end of each arm 13 of the frame 3, which provide minimal friction while maintaining the position of the blade 5. The blade 5 is rotationally mounted in a loop around the blade guides 31 and the driven gear 29.

Tension on the blade 5 is maintained and adjusted using a tension device 33 mounted between the arms 13. The tension device 33 includes an adjustment nut 35 and an adjustment screw 37 operatively connected to tension blades 39, such as pulleys or roller bearings. The tension rollers 39 are adjustably mounted within slots on the arms 13 so that they slide toward and away from the blade 5, thereby, adjusting the tension on the blade 5. Rotating the adjustment nut 35 along the adjustment screw 37 increases or decreases the distance between the tension rollers 39 toward and away from the blade 5. Decreasing the distance between the tension rollers 39 increases the tension of the blade 5, while increasing the distance between the tension rollers 39 decreases the tension on the blade 5. The adjustment of the tension device 33 allows the operator to adjust the blade 5 to match a particular coping cut. The tension device 33 also permits easy blade 5 replaced by removing tension on the blade 5 allowing blade 5 removal from the blade guides 31 and driven gear 29 and the re installation of a replacement blade.

Those skilled in the art will recognize that other types of tension devices may be used.

The relative positions between the arms 13, the handle 2, and the blade 5 allow the cutting surface 9 of the blade 5, which extends between the blade guides 31, to operate in a direction that is normal to the longitudinal axis A-A of the handle 2. In addition, this arrangement results in a compact design that positions the cutting surface 9 in close proximity to the handle 2. As a result, this arrangement provides a degree of stability and control of the coping saw 1 that allows the operator to precisely and accurately control the cutting surface 9 along curves, notches, and protrusions, including those involved in coping. In addition, this arrangement provides an operator an unrestricted view of the cut being made during operation, which is one of a number of distinguishing features of the invention from prior art. Another advantage of the saw of the present invention is that generally flush cuts can be made in a work piece, for example, when the saw 1 is positioned perpendicularly to the work piece.

Handle 2 also includes a switch 41 operatively connected to the motor 17, which the operator engages to turn the motor 17 on and off, control the speed, or reverse the direction of the motor 17. In this embodiment, switch 41 is a trigger type momentary switch positioned adjacent the notches 15 for engagement by a finger. However, other types of switches may be used, such as a pushbutton switch. In addition, the switch 41 may be positioned in other locations for engagement by other methods, such as by a thumb.

For safety of operation, the coping saw 1 includes a cover 43 that surrounds the tension device 33 and gear system 21 and is secured with a fastener 45. Also, guards 47 are mounted to the ends of the arms 13 to protect the operator from the blade 5. The arms 13 themselves act as guards to protect the operator from the blade 5. If necessary an additional guard 80 as shown in FIG. 7, may be placed along the cutting area of the blade.

In operation, the operator grips the handle 2 and engages the switch 41 to turn on the motor 17 of coping saw 1. The motor 17 transfers power through the gear system 21 to drive the blade 5 around the blade guides 31. If necessary, the operator adjusts the tension on the blade 5 by adjusting the tension device 33. Once the motor 17 is turned on, the operator guides the coping saw 1 and cutting surface 9 precisely and accurately along a desired cutting path including any curves, notches, and protrusions.

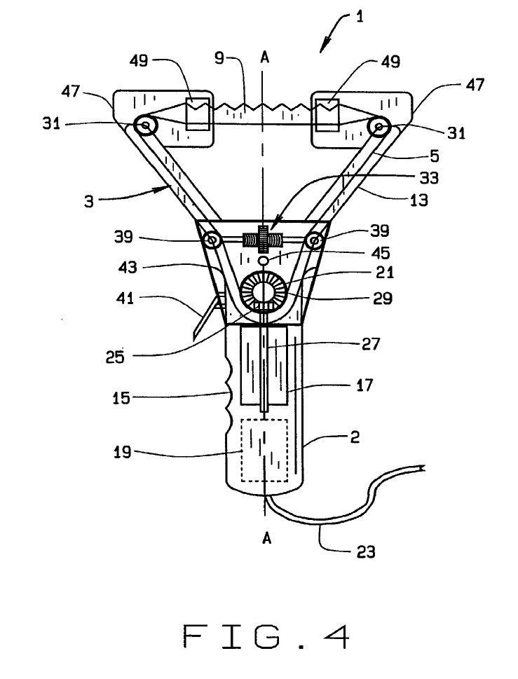

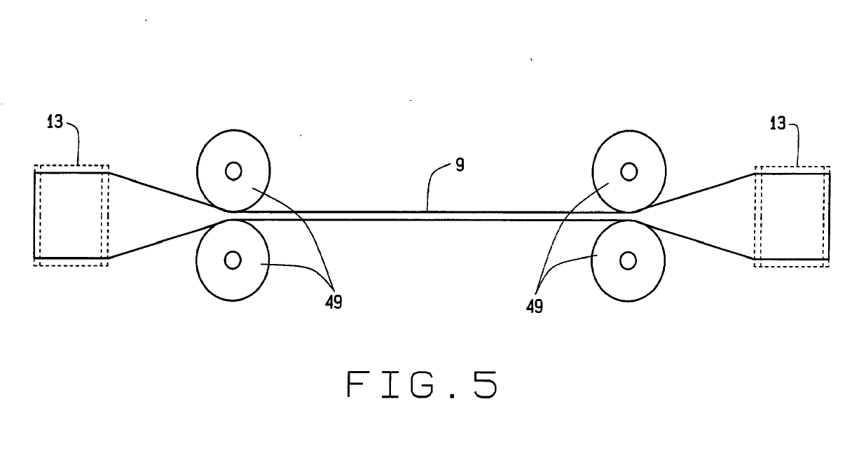

The present invention can also be embodied in the form of the coping saw 1 shown in FIGS. 4-5. In this embodiment, the coping saw 1 includes bending rollers 49 mounted to the arms 13 for changing the plane of cutting surface 9. The bending rollers 49 are positioned at each end of the cuffing surface 9 parallel with the longitudinal axis A-A of the handle 2. In this way, the bending rollers 49 rotate the angle of the cutting surface 9 relative to the rest of the blade 5. As shown in FIGS. 4-5, the cutting surface 9 is rotated 90° relative to the rest of the blade. However, the bending rollers 49 may be adjusted to rotate the cutting surface 9 more or less than 90°.

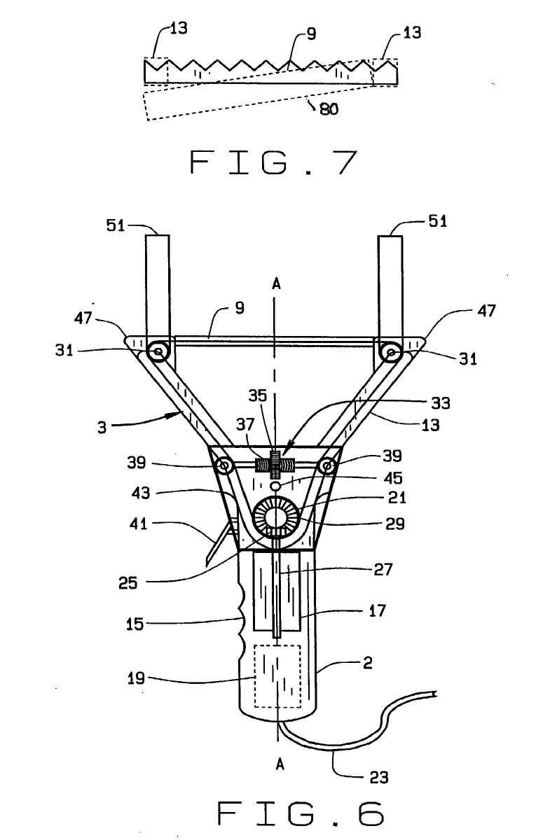

The present invention can also be embodied in the form of the saw 1 shown in FIG. 6. In this embodiment, arms 13 are pivotally mounted to the handle 2 so that the cutting surface 9 may be rotated about the longitudinal axis A-A of the handle 2. This allows the operator to adjust the angle of the cutting surface 9 relative to the longitudinal axis A-A of the handle 2. Also included in this embodiment are material guides 51 that are pivotally attached to the blade guides 31. The material guides 51 may be pivoted about the blade guides 31 from an open and closed position.

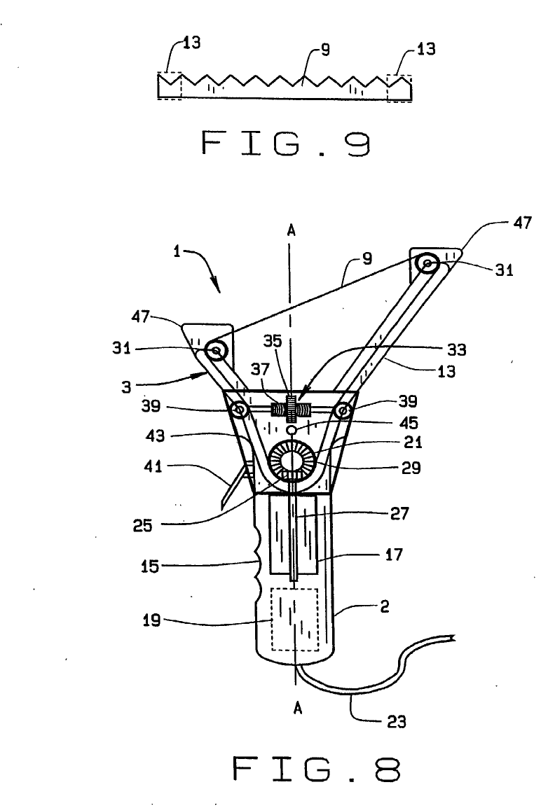

The present invention can also be embodied in the form of the coping saw 1, as shown in FIG. 8. In this embodiment, arms 13 may be adjusted in length so that the angle of the cutting surface 9 relative to the longitudinal axis A-A of the handle 2 may be adjusted. The relative positions between the between the adjustable arms 13, the handle 2, and the blade 5 provides a degree of stability and control that allows the operator to precisely and accurately control the cutting surface 9 of the blade 5 along curves, notches, and protrusions, including those involved in coping. In addition, this arrangement results in a compact design that positions the cutting surface 9 in close proximity to the handle 2.

Changes can be made in the above constructions without departing from the scope of the invention, it is intended that all matter contained in the above description or shown in the accompanying drawings shall be interpreted as illustrative and not in a limiting sense.

What is claimed is:

1. A powered saw comprising:
a frame including at least two spaced arms extending from a handle;
at least two blade guides attached to the frame;
a blade positioned in a coplanar relationship with the frame along the blade guides, the blade including a cutting surface extending between the arms of the frame;
a motor operatively connected to the blade; and
a power supply operatively connected to the motor.

2. The powered saw of claim 1, further comprising:
a tension device attached to the frame and engaged with the blade for increasing and decreasing the tension on the blade.

3. The powered saw of claim 2, wherein the tension device comprises:
tension rollers adjustably mounted to the frame;
an adjustment screw operatively connected to the tension rollers; and
an adjustment nut that is adjusted along the adjustment screw to increase and decrease the distance between the tension rollers and increase and decrease the tension of the blade.

4. The powered saw of claim 1, further comprising:
a gear system for transferring power from the motor to the blade.

5. The powered saw of claim 4 wherein the gear system comprises:
a bevel gear attached to a drive shaft of the motor;
a driven gear engaged with the bevel gear and engaged with the blade.

6. The powered saw of claim 1, further comprising:
a switch operatively connected to the motor that allows the operator the vary the speed of the motor.

7. The powered saw of claim 1, further comprising:
a cover attached to the frame surrounding the gear system; and guards attached to the arms of the frame.

8. The powered saw of claim 1, wherein cutting surface of the blade is normal to the longitudinal axis of the handle.

9. The powered saw of claim 1, further comprising:
bending rollers attached to the frame that rotate the angle of the cutting surface relative to the rest of the blade.

10. The powered saw of claim 9, wherein the bending rollers rotate the cutting surface 90° relative to the rest of the blade.

11. The powered saw of claim 1, further comprising:
material guides pivotally attached to the frame that pivot from an open to a closed position.

12. The powered saw of claim 1, wherein the arms are adjustable in length so that the angle of the cutting surface relative to the longitudinal axis of the handle may be adjusted.

13. The powered saw of claim 1, wherein the arms are pivotally attached to the handle so that the cutting surface may be rotated about the longitudinal axis of the handle.

14. A powered saw comprising:
a housing defining a handle, the housing having a longitudinal axis;
a frame including a pair of arms extending outwardly from the handle, the arms defining a open throat;
at least two blade guides attached to the frame;
a blade positioned in a coplanar relationship with the frame along the blade guides, the blade including a cutting surface extending between the arms of the frame along the throat and generally normal to the axis of the handle; and
a drive source mounted in the housing, the drive source being operatively connected to the blade.

15. The powered saw of claim 14, further comprising:
a tension device attached to the frame and engaged with the blade for increasing and decreasing the tension on the blade.

16. The powered coping saw of claim 14, further comprising:
a gear system for transferring power from the drive source to the blade.

17. The powered saw of claim 14, further including a power source mounted in the housing and operatively connected to the drive source.

18. The powered saw of claim 14, further comprising:
bending rollers attached to the frame that rotate the angle of the cutting surface relative to the rest of the blade.

19. The powered saw of claim 14, further comprising:
material guides pivotally attached to the frame that pivot from an open to a closed position.

20. The powered saw of claim 14, wherein the arms are adjustable in length so that the angle of the cutting surface relative to the longitudinal axis of the handle may be adjusted.

21. The powered saw of claim 14, wherein the arms are pivotally attached to the handle so that the cutting surface may be rotated about the longitudinal axis of the handle.

22. A powered coping saw comprising:
a handle having a longitudinal axis;
a frame including at least two arms extending axially outwardly from the handle;
at least two blade guides attached to the frame;
a blade positioned along the blade guides, the blade including a cutting surface extending between the arms of the frame so that the cutting surface is normal to the longitudinal axis of the handle;
a motor operatively connected to the blade; and
a power supply operatively connected to the motor.

23. The powered coping saw of claim 22, further comprising:
a tension device attached to the frame and engaged with the blade for increasing and decreasing the tension on the blade.

24. The powered coping saw of claim 22, further comprising:
a gear system for transferring power from the motor to the blade.

25. The powered coping saw of claim 22, further comprising:
bending rollers attached to the frame that rotate the angle of the cutting surface relative to the rest of the blade.

26. The powered coping saw of claim 22, further comprising:
material guides pivotally attached to the frame that pivot from an open to a closed position.

27. The powered coping saw of claim 22, wherein the arms are adjustable in length so that the angle of the cutting surface relative to the longitudinal axis of the handle may be adjusted.

28. The powered coping saw of claim 22, wherein the arms are pivotally attached to the handle so that the cutting surface may be rotated about the longitudinal axis of the handle.

29. The powered coping saw of claim 22, wherein the frame is Y-shaped.
